(19) United States
(12) Patent Application Publication
(10) Pub. No.: US 2013/0005887 A1
(43) Pub. Date: Jan. 3, 2013

(54) PROCESS TO PREPARE ADDITIVE PACKAGES FOR USE IN PVC COMPOUNDING

(75) Inventors: Tadeu Lellis, Sao Paulo City (BR); Pedro M. De Lima, Sao Paulo (BR); Jian-Yang Cho, Ambler, PA (US)

(73) Assignees: Dow Brasil S.A., Sao Paulo - Sp (BR); Rohm and Haas Company, Philadelphia, PA (US)

(21) Appl. No.: 13/534,671

(22) Filed: Jun. 27, 2012

Related U.S. Application Data
(60) Provisional application No. 61/503,226, filed on Jun. 30, 2011.

(51) Int. Cl. C08L 27/06; C08K 5/37

(52) U.S. Cl. 524/395

(57) ABSTRACT

A process for preparing a one-pack additive package for use in PVC compounding includes the steps of absorbing liquid additives, if any, into a nucleus; blending the nucleus with solid lubricant(s); then blending optional solid additives and optional drying agents therewith to obtain a free-flowing, dry blend, particulate one-pack. The resulting layered dry blend composition may then be pelletized, if desired. Because liquids are absorbed into the nucleus and then the temperature is maintained, during and after the lubricant blending step, at least 5° C. below the melt temperature of the lowest melting lubricant wax, no free liquids are present and potential interactions between additives are avoided.

### CROSS-REFERENCE TO RELATED APPLICATIONS

This application is a non-provisional application claiming priority from the U.S. Provisional Patent Application No. 61/503,226, filed on Jun. 30, 2011, entitled “PROCESS TO PREPARE ADDITIVE PACKAGES FOR USE IN PVC COMPOUNDING,” the teachings of which are incorporated by reference herein, as if reproduced in full hereinbelow.

The invention relates to the field of compounding of halogen-containing polymers (polyvinyl chloride, chlorinated polyvinyl chloride, polyvinylidene chloride, chlorinated polyethylene, polyvinylidene fluoride, and copolymers of vinyl chloride and vinylidene chloride), and more particularly to a process for preparing additive packages that may be used to improve efficiency and convenience in compounding such polymers.

Polyvinyl chloride (PVC) and its relatives listed hereinabove, hereinafter collectively termed “PVC” and “halogen-containing polymers,” are polymers that are frequently formulated with a variety of additives in order to customize them for specific applications. These additives most typically include heat stabilizers and both external and internal lubricants, and may also include plasticizers, processing aids, impact modifiers, pigments, fillers, light stabilizers, antioxidants, and the like.

Additives may be incorporated into the PVC resin by weighing out each additive and then charging it to the resin batch, often in a specific order, in a blender. High intensity mixing and external heating then provide sufficient heat to raise the batch temperature, which will melt the lubricants and disperse and incorporate all of the additives into the PVC polymer to form a PVC compound. The result of this process is a PVC compound in the form of a “dry blend.” The dry blend may then be used as a feed in various types of transformation equipment, such as extruders, injection molding machines, and the like.

There are many advantages to the careful blending protocol described hereinabove. These include the facts that any additives exhibiting poor powder flow properties can be incorporated with the PVC polymer in a batch step; the PVC compound will be reasonably homogeneous with all additives being relatively well-dispersed; any liquid additives, such as stabilizers or plasticizers, will be able to be homogenized with the PVC polymer; segregation of inorganic solids will be minimized; and the final PVC compound will generally be in the form of a reasonably free-flowing powder prior to feed into transformation equipment.

However, if there are a high number of additives in a formulation, the above-described compound production method is relatively slow. It is also subject to errors in measuring and weighing of the additives. Furthermore, it can lead to poor dispersion of additives which are in low concentrations. These disadvantages are significant and ultimately expensive to both compounders and product customers.

To reduce or avoid these disadvantages, the one-pack technology was developed. It is a technology wherein formulation ingredients in low concentrations (or “micro ingredients”) are combined in a pre-dispersed package, called a one-pack. There are two common types of methods to produce one-packs.

One of the commonly employed processes to prepare one-packs is called the “lubricant melt process.” For this process a lubricant is typically melted (obviously, at a temperature above its melting point) in a reactor to form a liquid medium. In this medium all other ingredients are then added and mixed to form a homogeneous mixture before converting to finished one-pack products in various physical forms. Such physical forms may include, for example, flakes, beads, powder, or pastilles.

In another method, referred to as a compaction process, all additives are mixed and homogenized using a low or medium intensity mixer, such as a ribbon blender. The powder is then compacted through a hot extruder or a rotating disc in the presence of a liquid binder. The binders are usually lubricants that have been melted either by external heating sources or by frictional heat. These steps enable uniform pelletization of the binder-powder mixture, which helps to ensure acceptable flowability and avoid segregation of powder components.

Unfortunately, the above-described processes to produce one-packs frequently encounter problems. If a one-pack formula contains high amounts of liquid additives, the resulting one-pack material may be wet or sticky and have poor flowability. If the amount of inorganic solid additives is relatively high, the final pellets may have poor cohesivity and consistency. Additives such as processing aids and impact modifiers, which often have relatively low gelation temperatures, are often somewhat difficult to incorporate into one-packs. Moreover, undesired chemical reactions may occur at high processing temperatures. In addition, more expensive and complex production equipment and processes are often required. In sum, the two methods described hereinabove have many limitations in producing a wide variety of one-pack formulations.

In view of all of the above drawbacks, there remains a need in the art for processes to provide a simple, practical, and versatile means to prepare one-packs.

In one embodiment, the present invention provides a process for preparing a one-pack additive package for a halogenated polymer formulation comprising (a) selecting a nucleus material, at least one solid lubricant, optionally at least one liquid additive, optionally at least one solid particulate additive, and optionally at least one drying agent; provided that if more than one solid lubricant is selected, the solid lubricant having the lowest melting point is used to determine the temperature in part (c); (b) if the optional at least one liquid additive is selected, absorbing the at least one liquid additive into the nucleus to form a nucleus-liquid composition; (c) blending the nucleus or nucleus-liquid composition with the at least one solid lubricant at a temperature at least 5 degrees Celsius (° C.) below the melting point of the at least one solid lubricant having the lowest melting point, such that a layered nucleus-lubricant or nucleus-liquid-lubricant composition is formed; (d) optionally blending the at least one solid additive with the nucleus-lubricant or nucleus-liquid-lubricant composition such that a layered nucleus-lubricant-solid or nucleus-liquid-lubricant-solid composition is formed; (e) optionally blending the nucleus-lubricant, nucleus-liquid-lubricant, nucleus-lubricant-solid or nucleus-liquid-lubricant-solid composition with at least one drying agent such that a layered nucleus-lubricant-drying agent, nucleus-liquid-lubricant-drying agent, nucleus-lubricant-solid-drying agent, or nucleus-liquid-lubricant-solid-drying agent composition is formed; and (f) optionally pelletizing the nucleus-lubricant, nucleus-liquid-lubricant, nucleus-lubricant-solid, nucleus-liquid-lubricant-solid, nucleus-lubricant-drying agent, nucleus-liquid-lubricant-drying agent, nucleus-lubricant-solid-drying agent, or nucleus-liquid-lubricant-solid-drying agent composition to form pellets.

In a second embodiment, the invention provides a one-pack additive package composition for use in halogenated polymer compounding, comprising a particulate solid nucleus, wherein the particulate solid nucleus optionally has absorbed therein at least one liquid additive; and wherein the particulate solid nucleus has a layer of a lubricant wax over a substantial portion thereof; and wherein the layer of the lubricant wax optionally has a layer of a solid additive optionally over a substantial portion of the layer of the lubricant wax; and wherein the layer of the lubricant wax or the solid particulate additive optionally has a layer of drying agent thereover; and wherein the additive package composition is a particulate solid that exhibits the characteristic of being substantially free-flowing.

In a third embodiment, the invention provides a one-pack additive package composition for use in halogenated polymer compounding, prepared by a process comprising (a) selecting a nucleus material, at least one solid lubricant, optionally at least one liquid additive, optionally at least one solid particulate additive, and optionally at least one drying agent; provided that if more than one solid lubricant is selected, the solid lubricant having the lowest melting point is used to determine the temperature in part (c); (b) if the optional at least one liquid additive is selected, absorbing the at least one liquid additive into the nucleus to form a nucleus-liquid composition; (c) blending the nucleus or nucleus-liquid composition with the at least one solid lubricant at a temperature at least 5 degrees Celsius (° C.) below the melting point of the at least one solid lubricant having the lowest melting point, such that a layered nucleus-lubricant or nucleus-liquid-lubricant composition is formed; (d) optionally blending the at least one solid particulate additive with the nucleus-lubricant or nucleus-liquid-lubricant composition such that layered nucleus-lubricant-solid or nucleus-liquid-lubricant-solid composition is formed; (e) optionally blending the nucleus-lubricant, nucleus-liquid-lubricant, nucleus-lubricant-solid or nucleus-liquid-lubricant-solid compositions with at least one drying agent such that a layered nucleus-lubricant-drying agent, nucleus-liquid-lubricant-drying agent, nucleus-lubricant-solid-drying agent, or nucleus-liquid-lubricant-solid-drying agent composition is formed; and (f) optionally pelletizing the nucleus-lubricant, nucleus-liquid-lubricant, nucleus-lubricant-solid, nucleus-liquid-lubricant-solid, nucleus-lubricant-drying agent, nucleus-liquid-lubricant-drying agent, nucleus-lubricant-solid-drying agent, or nucleus-liquid-lubricant-solid-drying agent composition to form pellets.

In brief summary, the invention offers the particular advantages of maintaining low one-pack production temperatures, enabling production of a wide variety of one-packs, and enhancing flowability thereof. In order to achieve this, a particular protocol is employed.

The first step of the process is to select a suitable nucleus material. As defined herein, the nucleus material is a solid particulate that is part of the finished one-pack product formulation, and is also one that will enhance, or at least not interfere with, the desired properties of the completed PVC compounded formulations. For example, if one or more of the required additives will be liquid, the nucleus should be sufficiently absorptive. In another example, if the final PVC formulation is destined for a use wherein transparency is desired, an opaque filler such as calcium carbonate would be an undesirable selection as the nucleus material. Appropriate selections for the nucleus material may thus include, in non-limiting example, the compounding resin itself, i.e., the PVC resin; a filler material, such as calcium carbonate; an impact modifier, such as an acrylic polymer additive; a processing aid; a pigment; or a combination thereof. In particular and non-limiting embodiments a preferred nucleus material is filler, PVC resin, acrylic polymer additive, impact modifier or pigment; and a more preferred nucleus material is PVC resin or filler.

In one non-limiting embodiment of the inventive process, it is also necessary to select all of the additive components for the one-pack additive package desired for a particular formulation. In general, however, essentially all additive packages require at least one lubricant. Frequently more than one such lubricant is selected, which serve to improve processability of the final formulation. For purposes of the invention, however, identification of a key lubricant is important. This key lubricant is the one having the lowest melting point, because it will be necessary to ensure that, during and after the lubricant is incorporated in the package, the temperature of the package is not allowed to rise above a point at least 5° C. below that lowest melting point. Possible lubricant selections may include, for example, petroleum waxes, e.g., paraffin wax; synthetic hydrocarbon waxes, e.g., oxidized and non-oxidized polyethylene waxes; montan (lignite) waxes; metal soaps of fatty acids; fatty acids; and combinations thereof.

Another additive commonly employed in additive packages is a heat stabilizer, since heat stabilizers are normally required in PVC compounded formulations. Such may be a liquid or particulate (dry solid or powder) material. Suitable examples may include organotin stabilizers, lead stabilizers, mixed metal stabilizers, and metal-free stabilizers based on organic molecules. Other additives may include a variety of types, including but not limited to, for example, light stabilizers, such as benzophenones and benzotriazoles; pigments, such as titanium dioxide, carbon black, etc.; fillers, such as calcium carbonate, talc, etc.; processing aids and impact modifiers, such as acrylic polymers, methyl methacrylate-styrene-butadiene copolymers, copolymers of methyl methacrylate and alkyl acrylates, etc.; antioxidants, such as phenolic antioxidants, etc.; and fire retardants/smoke suppressors, e.g., alumina trihydrate and magnesium hydroxide; and combinations thereof.

Once all materials have been selected, the first step is to accomplish the absorption by the nucleus of any of the additives that are liquid. This step is optional, because there may be a need to prepare a one-pack of the invention that does not include any liquid additives. Because the absorption can be done at a variety of temperatures, the term liquid additive as used herein means liquid at room temperature, which is the temperature at which the nucleus material is a particulate solid. Thus, for example, if PVC resin is the selected nucleus material, the absorption of all liquid additives may be accomplished, if desired, at a relatively high temperature, i.e., above PVC resin's Tg (glass transition temperature), at which PVC has higher porous volume and therefore enhanced capacity to absorb liquids. However, if an inorganic, such as a filler, a pigment, or the like will be the nucleus material, the absorption may be carried out at a low temperature, and preferably at room temperature.

The goal in this step is to ensure that, though a liquid is involved, the resulting combination of liquid and nucleus material produces a dry blend. As defined herein, dry blend means that the resultant nucleus containing all of the liquid(s) and yet still remains with an essentially particulate characteristic, with a considerable degree, upon visual inspection, of flowability and powder characteristic and absent significant segregation of components and/or aggregation of nucleus material. Two things must be controlled in order to ensure this. First, the amount of the nucleus material in proportion to the amount of the liquid additive(s) should be such that absorption of the liquid(s) can be essentially complete. Second, it is also important to control the rate of liquid(s) addition such that the addition rate is slower than the absorption rate by the selected nucleus.

The absorption procedure can be carried out using any typical high speed mixing and/or blending equipment. In certain particular but non-limiting embodiments the equipment has the capability to ensure good powder homogenization and additive dispersion. If desired, the process temperature can be controlled by the heating-cooling jacket in the mixer. For example, if PVC resin is chosen as the nucleus and the one-pack has a high proportion of liquid additive content, it is often desirable to increase the process temperature to above the Tg of the PVC resin to adequately absorb the liquids. Those skilled in the art will be aware of a variety of equipment manufacturers and mixing and blending parameters to enable them to easily determine appropriate measures to accomplish absorption.

Once the optional liquid components have been absorbed into the nucleus material, the nucleus is blended with at least one solid lubricant. Where more than one lubricant will be included in a given formulation, it is typically preferred to include them all at this point. The exception to this preference is liquid lubricants, which are desirably absorbed in the nucleus at the same time as other liquid additives, i.e., in the optional first step. As already noted hereinabove, this blending is carried out at a temperature at least 5° C. below the melting temperature of the lowest melting lubricant. In fact, it is essential to maintain this low blending temperature throughout the remainder of the blending process to avoid actual melting of any of the lubricant waxes. Blending is desirably high-intensity mixing to ensure homogenization and dispersion of the mix, but cooling jacketing is therefore also desirable to maintain the desired temperature control. This is because higher intensity blending tends to result in increased frictional heat.

Since lubricants are frequently, but not always, tacky or sticky materials, as the terms are colloquially understood, blending such with the nucleus, or nucleus-liquid, material often, and in some embodiments desirably, may result in formation of a composition having a sticky surface. As defined herein, sticky means an area showing enhanced adhesivity or tack, such that the lubricant is preferentially adhered to the nucleus particles and also does not exhibit a degree of cohesivity that results in significantly enhanced aggregation of the composition. In this situation, the nucleus-lubricant, or nucleus-liquid-lubricant, composition will desirably maintain a degree of flowability that is not, upon visual inspection, significantly reduced when compared with that of the nucleus material alone.

Following incorporation of the lubricants in the composition, any optional, additional additives that are solids may then be blended with the nucleus-lubricant or nucleus-liquid-lubricant composition. Such solid additives will desirably, and conveniently, adhere to a measurable extent to the lubricant layer of the composition, producing a second layer over a substantial portion or essentially all of the surface. Where the additional additives lack significant cohesive properties, the one-pack additive package may desirably now be in the form of a substantially free-flowing powder and may be a complete and finished one-pack, ready for compounding with the desired PVC base resin. This composition is now either a nucleus-lubricant-solids or nucleus-liquid-lubricant-solids composition. If there are no solid optional additives included, it remains a nucleus-lubricant or nucleus-liquid-lubricant composition at this point.

If, however, the layer of solid (particulate) additives exhibit some cohesion and the nucleus-lubricant-solids or nucleus-liquid-lubricant-solids composition thus remains, at least to some extent, a sticky particulate or otherwise has an insufficient or undesirable degree of flowability, it may be desirable to then blend therewith, in an optional final step, a so-called drying agent. This may also be the case where no solid additives are included, and the composition is a nucleus-lubricant or nucleus-liquid-lubricant composition. Such drying agent, which is optional, may be used to overcome the stickiness, i.e., enhanced cohesion and/or adhesion, by effectively establishing and maintaining a relatively non-sticky, substantially continuous layer on the outermost surface of each particle. The result of this is, again, a dry, i.e., dry blend, and substantially free-flowing powder. Suitable examples of such drying agents may include any solid present in the formulation that has not already been included in the additives solid additives blending step, or as to which only a part thereof has already been added in the solid additives blending step. It may also be a completely different drying agent selected for this purpose alone. Such may include, for example, fillers; impact modifiers; processing aids; pigments; one of the halogenated polymer resins; and combinations thereof.

Following completion of the product, with or without a drying agent, the additive package composition may be pelletized. This optional step can be carried out by combining the composition with a binder. The binder can come from an external source, i.e., a liquid binder slowly added to assist in pelletization, or an internal source, which means that a binder is generated in situ by slowly increasing the blender temperature until a binder-generating additive begins to melt. At this point the combination of the blender's radial speed and the amount of binder actually present in the vessel, moment by moment, determine the average diameter of the pellets as they are formed.

The final free-flowing PVC one-pack additive package prepared by the inventive process is then ready to be blended with the rest of the major, or “macro,” ingredients of the formulation to form the final compounded PVC product. This compounded PVC product may then be introduced into transformation equipment to produce PVC articles. Such articles may include pipe, roses, fittings, profiles, rigid and flexible films, bottles, electrical conduits, sidings, foam boards, wire and cables, and the like.

The present invention does not require melting of lubricants, nor presence of liquids. Thus, the present invention offers, in comparison with the lubricant melt process and the compaction process, the convenience of preparation and appropriate customization to an end application; reduced tendency toward chemical interactions between additives; reduced opportunity for degradation of any additive components due to high temperature; reduced opportunity for components segregation; higher versatility in using many different additives in wider amount ranges; the potential to more easily include incompatible additives; lower capital investment and equipment cost; higher production rate and lower production cost; and facilitated production of customized products.

### EXAMPLES

### Example 1

### Step 1: Liquids Absorption

500 grams (g) of PVC resin (Kw=65, 20%<porosity<30%, as the nucleus material, designated as Nucleus A) and 250 g of Advastab™ TM-181FS (methyl tin thioglycolate, a liquid heat stabilizer) are used as raw materials and a Haake Planetmix™ 500 is used to function as a planetary mixer, equipped with heating and cooling jacket. Mixer rotation speed is fixed at 1000 rpm. The PVC resin is first charged into the mixer, when the temperature of the PVC resin reaches 80° C. in approximately 4 minutes (min). TM-181FS liquid stabilizer is then gradually added, at an average rate of 1 kilogram per hour (kg/h). The total addition of TM-181FS is 250 g.

In the first 5 minutes the rate of absorption is observed to be faster than the rate of liquid addition. During this period the torque is very low and the powder behaves like a dry blend. After this period the rate of absorption begins to be slower than the rate of addition, the mix begins to get a little bit wet and the torque of the mixer increases. The addition of TM-181FS is completed in approximately 15 min. About 10 min after the liquid addition is complete, the torque of the mixer starts to decrease and the mix begins to be dry again, showing good flowing behavior as a dry blend or a pure PVC resin. The average absorption rate is estimated under these conditions to be about 1.2 kg of TM181FS/kg of PVC resin/hour.

This free-flowing powder has 66.7 weight percent (wt %) of PVC resin and 33.3 wt % of methyl tin thioglycolate stabilizer, based on total weight of resin and stabilizer together. This mix is herein designated as a nucleus-liquid composition.

Step 2: Incorporating Other Additives onto Surface of Nucleus-Liquid Composition

Using the same mixer and speed as in Step 1, but at a constant temperature of 35° C., 250.0 g of the nucleus-liquid composition are added into the mixer, followed by slow addition of lubricants according to the following sequence: paraffin wax=166.7 g (refined paraffin wax, melting point: 70-74° C.); AC-629A=16.7 g (oxidized polyethylene wax, drop point: 101° C.) and calcium stearate=133.3 g (melting point: 150-155° C.). After mixing at 35° C. for 10 min, the resulting mix is a free-flowing and dust-free powder, with good homogeneity and without segregation issues, per visual inspection. This blend is designated as one-pack Example 1.

### Example 2 and Comparative Example A

A formulated PVC sample, including the same additive components as in Example 1, is prepared by blending the individual components, i.e., weighing and incorporating each component separately. This sample is denominated Comparative Example A and is done in a high speed Henschel blender. For preparation of Comparative Example A, PVC resin is charged into the blender with tin stabilizer at room temperature. All lubricants are charged at 70° C. and inorganic components are charged at 85° C. Once the batch temperature reaches 110° C., the compound is then cooled down to about 40° C. in a cooler.

For preparation of the Example 2 compound, the PVC resin and the one-pack prepared in Example 1 are charged into the blender at room temperature. Temperature is raised to 110° C. and the compounded PVC is then cooled down to about 40° C. in a cooler.

TABLE 1
Formulations of Example 2 and Comparative Example A.

| | Non-one-pack process | Includes one-pack |
|---|---|---|
| | Comparative | from Example 1 |
| Component | Example A (phr)* | Example 2 (phr)* |
| PVC resin, Kw = 67 | 100 | 99 |
| TiO₂ | 0.5 | 0.5 |
| CaCO₃, 2μ, not treated | 15 | 15 |
| One-pack Example 1 | — | 3.4** |
| Advastab ™ TM-181FS | 0.5 | — |
| Calcium stearate | 0.8 | — |
| Paraffin wax, XL-165 | 1.0 | — |
| Oxidized PE wax, AC-629A | 0.1 | — |
| Total | 117.9 | 117.9 |

*phr = parts per hundred resin
**3.4 phr one-pack Example 1 = 1.0 phr of PVC resin + 0.5 phr of TM-181FS + 0.8 phr of calcium stearate + 1.0 phr of paraffin wax + 0.1 phr of AC-629A.

The Example 2 sample is compared rheologically with the Comparative Example A sample using a Haake Polylab OS torque rheometer. The same rheological behavior (same equilibrium torques, fusion time and curve shapes) are observed for both formulations.

### Example 3

The Example 3 one-pack has a formula with a relatively high liquid content and is prepared using a rotating mixer pan. The composition of this one-pack has 46.1% of liquid (stabilizer) and 53.9% of solid lubricants. It is difficult to prepare such a one-pack by following any of the known one-pack production methods. This invention overcomes the problem by employing the liquid-absorbing nucleus. In this example, the selected nucleus material is CaCO₃ (natural calcite, φₐᵥ=2 μm and not treated with stearic acid). This CaCO₃ has a porous rate of 44% (bis(2-ethylhexyl) phthalate (DOP) absorption, mass-mass) and is used in an amount of more than twice the amount of liquid (Advastab™ TM-599A—a methyl tin reverse ester stabilizer). The one-pack Example 3 composition is shown in Table 2.

TABLE 2
One-pack formula of Example 3.

| Components | wt % |
|---|---|
| Advastab ™TM 599A, liquid heat stabilizer | 23.1 |
| Calcium stearate | 10.3 |
| XL-165, paraffin wax | 13.0 |
| AC-629A, oxidized PE wax, drop point = 101° C. | 1.9 |
| Stearic acid, triple pressed | 1.9 |
| CaCO₃, not treated, calcite, φₐᵥ = 2 μm | 50.0 |
| Total | 100.0 |

### Step 1: Liquids Absorption and Lubricants Addition

The Example 3 one-pack is prepared using a high intensity blender with a rotating pan (Erich lab mixer, 15 liters (L), no jacket for temperature control). The process is carried out at room temperature (˜28° C.). Into the mixer pan is placed 4.90 kg of CaCO₃ as the nucleus material (0.10 kg is set aside to use later as a drying agent). In medium rotation 1.62 kg of Advastab™ TM-599A (0.69 kg is set aside for use later as a binder in the pelletizing step) is introduced very slowly into the pan. Following liquid absorption, the lubricants are slowly introduced in this sequence: stearic acid=0.19 kg; XL-165 (AmeriLubes)=1.30 kg; AC-629A (Honeywell)=0.19 kg; calcium stearate=1.03 kg. The rotation speed is changed from medium to high and after a few minutes the powder is dry with good flow properties, per visual inspection.

### Step 2: Pelletization

0.69 kg of Advastab™ TM-599A is added slowly under high rotational speed, as a binder. The addition time is about 3 minutes. The pellets' diameters are controlled by the liquid addition rate and the mixer rotation speed. At the end of the pelletizing process 0.10 kg of CaCO₃ is added slowly to dry the surface of pellets. The resulting one-pack material is free-flowing and about 65% of the granules has diameters (φ) measuring 1.0 mm≦φ≦3.0 mm; about 20% has φ≦1.0 mm; and about 15% has φ≧3.0 mm.

### Example 4

A horizontal plow mixer (Littleford Day blender/granulator, FKM series, with heating and cooling jacket, without choppers, 15 L pan) is used to prepare the Example 4 one-pack. The formula of the one-pack, as shown in Table 3, includes several components as the nucleus, including filler (calcium carbonate), the acrylic impact modifier (Paraloid™ KM-362), and the CPE impact modifier (Tyrin™ 7100). The pigment is used as a drying agent. The entire process is carried out at ambient temperature with high speed rotation.

TABLE 3
One-pack formula of Example 4.

| Components | % |
|---|---|
| Advastab ™ TM-181FS, tin stabilizer | 9.2 |
| Advalube ™ E-2100, lubricant | 6.1 |
| Calcium stearate, lubricant | 5.0 |
| Low density oxidized PE wax, lubricant | 1.5 |
| High density oxidized PE wax, lubricant | 1.2 |
| Paraloid ™ KM-362, acrylic impact modifier | 25.0 |
| Tyrin ™ 7100, CPE impact modifier | 16.0 |
| TiO₂, rutile, pigment | 6.0 |
| CaCO₃, calcite, φ = 2 μm, not treated, filler | 30.0 |
| Total | 100.0 |

### Step 1: Liquid Absorption

Into the mixer are placed 2.50 kg of Paraloid™ KM-362, 1.60 kg of Tyrin™ 7100 and 3.00 kg of CaCO₃. 0.92 kg of Advastab™ TM-181FS is then added very slowly, under high speed rotation, over a period of 5 min. The resulting material is a free-flowing dry powder.

### Step 2: Lubricants Addition

Once the liquid absorption step is complete, all lubricants are added in the following sequence: Advalube™ E-2100 (0.61 kg), oxidized LDPE wax (0.15 kg), oxidized HDPE wax (0.12 kg), and calcium stearate (0.50 kg). The resulting material is a dust-free and free-flowing powder.

### Step 3: Drying Agent Addition

Even though the material already appears to have good flow properties, 0.60 kg of TiO₂ is used as a drying agent to enhance its flowability. The final material is a dust-free and free-flowing powder without segregation, per visual inspection.

What is claimed is:

1. A process for preparing a one-pack additive package for a halogenated polymer formulation comprising
(a) selecting a nucleus material, at least one solid lubricant, optionally at least one liquid additive, optionally at least one solid particulate additive, and optionally at least one drying agent; provided that if more than one solid lubricant is selected, the solid lubricant having the lowest melting point is used to determine the temperature in part (c);
(b) if the optional at least one liquid additive is selected, absorbing the at least one liquid additive into the nucleus to form a nucleus-liquid composition;
(c) blending the nucleus or nucleus-liquid composition with the at least one solid lubricant at a temperature at least 5 degrees Celsius (° C.) below the melting point of the at least one solid lubricant having the lowest melting point, such that a layered nucleus-lubricant or nucleus-liquid-lubricant composition is formed;
(d) optionally blending the at least one solid particulate additive with the nucleus-lubricant or nucleus-liquid-lubricant composition such that a layered nucleus-lubricant-solid or nucleus-liquid-lubricant-solid composition is formed;
(e) optionally blending the nucleus-lubricant, nucleus-liquid-lubricant, nucleus-lubricant-solid or nucleus-liquid-lubricant-solid composition with at least one drying agent such that a layered nucleus-lubricant-drying agent, nucleus-liquid-lubricant-drying agent, nucleus-lubricant-solid-drying agent, or nucleus-liquid-lubricant-solid-drying agent composition is formed; and
(f) optionally pelletizing the nucleus-lubricant, nucleus-liquid-lubricant, nucleus-lubricant-solid, nucleus-liquid-lubricant-solid, nucleus-lubricant-drying agent, nucleus-liquid-lubricant-drying agent, nucleus-lubricant-solid-drying agent, or nucleus-liquid-lubricant-solid-drying agent composition to form pellets.

2. The process of claim 1 wherein the nucleus is selected from the group consisting of polyvinyl chloride, chlorinated polyvinyl chloride, polyvinylidene chloride, chlorinated polyethylene, polyvinylidene fluoride, copolymers of vinyl chloride and vinylidene chloride, fillers, impact modifiers, processing aids, pigments, and combinations thereof.

3. The process of claim 1 wherein the lubricant is selected from the group consisting of petroleum waxes, synthetic hydrocarbon waxes, montan waxes, metal salts of fatty acids, fatty acids, and combinations thereof.

4. The process of claim 1 wherein the solid particulate additive is selected from the group consisting of calcium carbonate, talc, carbon black, titanium dioxide, benzophenones, benzotriazoles, acrylic polymers, methyl methacrylate-styrene-butadiene copolymers, copolymers of methyl methacrylate and alkyl acrylates, phenolic antioxidants, alumina trihydrate, magnesium hydroxide, and combinations thereof.

5. The process of claim 1 wherein the blending is carried out in a high intensity blender.

6. A one-pack additive package composition for use in halogenated polymer compounding, comprising a particulate solid nucleus, wherein the particulate solid nucleus optionally has absorbed therein at least one liquid additive; and wherein the particulate solid nucleus has a layer of a lubricant wax over a substantial portion thereof; and wherein the layer of the lubricant wax optionally has a layer of a solid particulate additive over a substantial portion of the layer of the lubricant wax; and wherein the layer of the lubricant wax or the solid particulate additive optionally has a layer of drying agent thereover; and wherein the additive package composition is a particulate solid that exhibits the characteristic of being substantially free-flowing.

7. A one-pack additive package composition for use in halogenated polymer compounding, prepared by a process comprising
(a) selecting a nucleus material, at least one solid lubricant, optionally at least one liquid additive, optionally at least one solid particulate additive, and optionally at least one drying agent; provided that if more than one solid lubricant is selected, the solid lubricant having the lowest melting point is used to determine the temperature in part (c);
(b) if the optional at least one liquid additive is selected, absorbing the at least one liquid additive into the nucleus to form a nucleus-liquid composition;
(c) blending the nucleus or nucleus-liquid composition with the at least one solid lubricant at a temperature at least 5 degrees Celsius (° C.) below the melting point of the at least one solid lubricant having the lowest melting point, such that a layered nucleus-lubricant or nucleus-liquid-lubricant composition is formed;
(d) optionally blending the at least one solid particulate additive with the nucleus-lubricant or nucleus-liquid-lubricant composition such that a layered nucleus-lubricant-solid or nucleus-liquid-lubricant-solid composition is formed;
(e) optionally blending the nucleus-lubricant, nucleus-liquid-lubricant, nucleus-lubricant-solid or nucleus-liquid-lubricant-solid compositions with at least one drying agent such that a layered nucleus-lubricant-drying agent, nucleus-liquid-lubricant-drying agent, nucleus-lubricant-solid-drying agent, or nucleus-liquid-lubricant-solid-drying agent composition is formed; and
(f) optionally pelletizing the nucleus-lubricant, nucleus-liquid-lubricant, nucleus-lubricant-solid, nucleus-liquid-lubricant-solid, nucleus-lubricant-drying agent, nucleus-liquid-lubricant-drying agent, nucleus-lubricant-solid-drying agent, or nucleus-liquid-lubricant-solid-drying agent composition to form pellets.
